(19) United States
(12) Patent Application Publication
(10) Pub. No.: US 2025/0371612 A1
(43) Pub. Date: Dec. 4, 2025

(54) SYSTEM FOR OPTIMIZING PAYMENTS AND CREDIT UTILIZATION WHEN MAKING ONLINE PURCHASES

(71) Applicant: Jackson Fuller, Frisco, TX (US)

(72) Inventor: Jackson Fuller, Frisco, TX (US)

(21) Appl. No.: 19/233,822

(22) Filed: Jun. 10, 2025

Related U.S. Application Data
(60) Provisional application No. 63/648,254, filed on May 16, 2024.

(51) Int. Cl. G06Q 40/02; G06Q 20/10; G06Q 20/32; G06Q 20/36; G06Q 30/0601

(52) U.S. Cl. CPC G06Q 40/023; G06Q 20/108; G06Q 20/3278; G06Q 20/36; G06Q 30/0641; G06Q 40/026

(57) ABSTRACT

The embodiments provided herein relate to a system for optimizing and automating the selection of a payment method used for online purchases. The system includes at least one user computing device in operable connection with a user network. An application server is in operable communication with the user network to host an application program for analyzing and determining an optimal method of payment. The application program includes a user interface module for providing access to the application program via the at least one user computing device. An online marketplace allows the user to select one or more goods and services and an analysis module for determining an optimal payment method using one or more financial metrics.

### CROSS-REFERENCE TO RELATED APPLICATIONS

This application claims the benefit of priority to U.S. Provisional Application No. 63/648,254 filed on February May 16, 2024, titled “SYSTEM FOR OPTIMIZING PAYMENTS AND CREDIT UTILIZATION WHEN MAKING ONLINE PURCHASES”, the entire contents of which are hereby incorporated by reference.

### TECHNICAL FIELD

The embodiments disclosed herein generally relate to online payment systems, and more specifically to a system for optimizing payment methods when purchasing goods and services online.

### BACKGROUND

Over the past two decades, digital commerce has undergone a transformation driven by the proliferation of high-speed internet, mobile devices, and fintech innovations. Consumers increasingly rely on online platforms and mobile applications to shop for goods and services, make reservations, pay bills, and manage subscriptions. This shift has been accompanied by the rise of digital wallets and mobile payment systems such as Apple Pay, Google Pay, and PayPal, which offer users greater flexibility in choosing how they pay for purchases. Meanwhile, financial institutions have flooded the market with various credit cards, each offering distinct reward structures, promotional incentives, and credit limits aimed at capturing customer loyalty and spend.

Despite these advances, consumers are left to manually decide which payment method to use in any given scenario. Choosing between cards often requires users to analyze their available credit, utilization percentage, remaining rewards, and which vendor is eligible for a particular cashback or loyalty program benefit. This manual approach is not only time-consuming but also error-prone, frequently resulting in suboptimal financial outcomes. For example, a user may unknowingly charge a purchase to a nearly maxed-out card, increasing their credit utilization ratio and negatively impacting their credit score. Alternatively, they may miss out on higher cashback or travel rewards by not selecting the most beneficial card for the transaction.

Prior attempts to simplify payment decisions have primarily focused on static recommendations or post-purchase reward optimization. Some platforms offer dashboards that aggregate account balances and reward summaries, but they do not dynamically intervene at the point of sale to influence payment decisions. Moreover, digital wallet applications allow storage of multiple payment instruments, but they do not provide intelligent recommendations or automate the selection process in a way that considers all relevant financial metrics and user preferences in real time. These systems typically lack predictive analytics, rule-based prioritization, and responsive adjustments based on transaction context.

The shortcomings of the prior art are further amplified in scenarios involving multiple reward systems and strict user-defined preferences, such as maintaining specific utilization thresholds for credit management or achieving targeted loyalty rewards. No commercially available system offers a unified platform capable of linking payment methods, integrating real-time financial data, applying intelligent decision rules, and executing the transaction automatically, all while honoring personal goals and financial health metrics. Accordingly, there exists a need for a comprehensive, real-time system that not only tracks and compares financial options but actively optimizes payment decisions for the consumer at the time of purchase.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a system for optimizing and automating the selection of payment methods for online and in-store transactions. It provides users with a comprehensive tool that intelligently evaluates financial data, user-defined preferences, and contextual purchase details. The system then selects the payment method that yields the most favorable outcome based on these inputs. By streamlining this process, users can avoid manual calculations, maximize reward benefits, and maintain healthy credit usage. This innovation improves transactional efficiency, promotes responsible credit behavior, and empowers users to derive greater financial value from each purchase.

The invention includes a user computing device, such as a smartphone, tablet, or computer, that facilitates interaction between the user and the payment optimization platform. Through this device, users can initiate purchases, link financial accounts, customize optimization settings, and view reports. The application interface is responsive and user-friendly, designed to support a wide range of financial literacy levels. This ensures accessibility for everyday users while still offering deep customization for advanced users. The computing device serves as the entry point for capturing transaction data and displaying optimization results in real time.

The user computing device is connected to a centralized application server via a network, which may include the Internet, a wireless communication channel, or a dedicated data connection. The application server hosts the core functionality of the system, including the analysis engine, financial integration modules, and optimization logic. It is responsible for processing incoming transaction data, communicating with third-party financial APIs, and returning optimized payment decisions to the user interface. This architecture allows the system to scale efficiently and provide consistent performance across various devices. It also supports continuous updates and improvements to the optimization engine without requiring manual intervention by the user.

A user interface module resides within the application program hosted on the user computing device. This module enables interaction between the user and the optimization system, presenting various dashboards, configuration panels, and transaction summaries. Through the interface, users can input their card preferences, assign value weights to different reward types, and set custom utilization thresholds. The interface also allows users to monitor their linked financial accounts and review historical transactions. This fosters transparency, user engagement, and trust in the system's automated decision-making.

The invention includes a powerful analysis module that acts as the decision engine for payment method selection. Upon receiving transaction data, including cost, vendor information, and purchase category, the module queries linked accounts for relevant financial information. This may include current balances, credit limits, interest rates, and real-time reward structures. The analysis module then processes this information using user-defined rules and scoring algorithms to determine the optimal method of payment. The use of real-time data ensures accuracy and aligns each recommendation with the user's financial goals and constraints.

The analysis module evaluates a broad set of financial metrics to inform its decision-making. These metrics include available credit, current utilization percentages, reward point valuation, and time-sensitive promotional offers. Each of these inputs is assigned a weight based on the user's preferences and objectives. This approach allows the system to tailor its decisions to each individual user's financial strategy. By using dynamic data inputs and configurable rules, the module generates highly personalized payment recommendations.

At the heart of the system is a scoring algorithm designed for flexibility and precision. The algorithm aggregates various weighted metrics, such as credit availability, utilization impact, and reward return on investment, into a comprehensive score for each payment method. These scores are compared across all eligible payment accounts, allowing the system to select the most advantageous method. Users have the option to adjust the weight of each metric according to their financial priorities. This gives users control over the optimization process while minimizing the effort required to manage complex financial data.

Once scores are calculated, the system selects the payment method with the highest overall score and uses it to process the transaction. If the system is operating in manual mode, it can display a ranked list of payment options, allowing the user to make the final decision. In automated mode, the system can execute the transaction without requiring further input. This dual-mode functionality allows the system to adapt to different user preferences for autonomy or control. It also reduces the cognitive load associated with frequent purchase decisions.

The digital wallet dashboard within the application aggregates data from all linked financial accounts. It displays real-time balances, available credit, utilization rates, and accumulated reward points across different programs. Users can view this data in a centralized location and access filters to sort and prioritize based on account type or reward value. This feature provides a holistic view of the user's financial position and helps them understand how their spending behavior influences rewards and credit health. It also enhances the user experience by offering visibility into the optimization engine's data sources.

The system facilitates secure account linking through integration with third-party financial data providers using tokenized API protocols. Providers such as Plaid allow the system to access financial data without storing sensitive credentials. This ensures that the connection to each account is encrypted, authenticated, and compliant with security standards. Users can link multiple credit cards, bank accounts, and digital wallets using this secure interface. This functionality is essential for building a comprehensive financial profile used during optimization.

A core benefit of the invention is the ability to set and enforce utilization thresholds for each payment method. These thresholds help users maintain responsible credit behavior by avoiding excessive utilization, which could negatively affect credit scores. The system continuously monitors account usage and automatically excludes any payment method that would exceed its designated threshold if used. This ensures compliance with user-defined limits and supports long-term financial health. It also reduces the risk of transaction rejections due to over-limit activity.

The system is capable of analyzing each payment method's reward potential based on current and projected values. It factors in vendor-specific bonuses, category multipliers, and loyalty program accelerators. By analyzing these reward variables in conjunction with user goals, the system maximizes the value of every transaction. This is particularly useful for users who belong to multiple programs with varying redemption rates. The system ensures that purchases are aligned with optimal earning strategies.

The invention supports a wide range of transaction types, including both e-commerce and in-store purchases. For in-store use, the system integrates with mobile wallet technologies, including NFC, to complete transactions at point-of-sale terminals. This ensures that users can benefit from optimized payment selections regardless of the purchase channel. The flexibility of the system makes it suitable for a broad spectrum of consumer use cases. It also encourages adoption by supporting existing payment habits.

The system may optionally apply a transaction service fee, which is collected automatically after the payment is completed. This fee is typically minimal, such as a fixed percentage of the transaction value, and is disclosed to the user during account setup. The service fee supports the platform's operational costs while remaining transparent and user-friendly. In some embodiments, the user may be able to choose between different fee models. This flexibility enhances the commercial viability of the system without sacrificing user trust.

The invention features a fully automated operation mode referred to as NavAutopilot. In this mode, the system evaluates transactions and initiates payments without user interaction, provided that optimization settings have been configured in advance. This mode is especially useful for routine purchases, such as subscriptions or recurring bills. Users can rely on the system to make financially intelligent decisions without interrupting their workflows. This increases convenience and strengthens the system's value proposition.

Users can assign monetary values to different types of rewards, such as miles, cashback, or hotel points. These values are used by the optimization engine to compare reward types across different accounts. For example, a user may assign a higher value to travel rewards and a lower value to general cashback. This creates a reward hierarchy that informs the scoring process. The system uses this hierarchy to align recommendations with user preferences.

The backend infrastructure is designed to support secure, scalable, and resilient operations. It can be deployed in cloud environments with load balancing and failover mechanisms to ensure uptime. All sensitive data is stored in encrypted databases and is protected with multiple layers of security. This infrastructure supports the integration of new features and services over time. It also allows the platform to serve a large and growing user base efficiently.

A transaction logging module records every event processed by the system, including transaction metadata, optimization decisions, and final execution details. These logs are accessible to users via the application dashboard and can be exported for financial review. This supports compliance, transparency, and informed decision-making. It also provides a historical basis for system improvements and user support. By keeping a detailed record of actions, the system ensures accountability and traceability.

The system improves credit health by distributing purchases across multiple accounts to reduce concentration of credit usage. This strategy helps maintain lower utilization percentages per account and improves the user's overall credit profile. In contrast to traditional payment tools, which favor default card usage, the system uses a balanced and intelligent approach. This can have long-term benefits for users seeking to build or maintain strong credit scores. It also reduces the likelihood of exceeding any single card's limit.

The reward optimization capabilities of the invention help users capture the full benefit of every transaction. By analyzing current promotions and reward structures, the system ensures that the best option is selected for each purchase. This can significantly increase the total value of rewards earned over time. For frequent travelers or high-volume shoppers, the financial impact can be substantial. The system converts ordinary spending into strategically valuable outcomes.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the computing system infrastructure, according to some embodiments;

FIG. 2 illustrates a block diagram of the payment optimization system architecture, according to some embodiments;

FIG. 3 illustrates a block diagram of the in-store purchase sequence, according to some embodiments;

FIG. 4 illustrates a block diagram of the in-store purchase sequence, according to some embodiments;

FIG. 5 illustrates a flowchart of a method for implementing the payment optimization system, according to some embodiments;

FIG. 6 illustrates a screenshot of the user dashboard interface, according to some embodiments;

FIG. 7 illustrates a screenshot of the user dashboard interface, according to some embodiments;

FIG. 8 illustrates a screenshot of the user dashboard interface, according to some embodiments;

FIG. 9 illustrates a screenshot of the user dashboard interface, according to some embodiments;

FIG. 10 illustrates a screenshot of the user dashboard interface, according to some embodiments;

FIG. 11 illustrates a screenshot of the user dashboard interface, according to some embodiments;

FIG. 12 illustrates a screenshot of the user dashboard interface, according to some embodiments; and

FIG. 13 illustrates a screenshot of the user dashboard interface, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before various example embodiments are described in detail, it is noted that the embodiments reside primarily in combinations of components and procedures related to systems. Accordingly, system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be systems, methods, and/or computer program products at any possible technical detail level of integration. A computer program product can include, among other things, a computer-readable storage medium having computer-readable program instructions thereon for causing a processor to carry out aspects of the present disclosure.

In general, the embodiments disclosed herein relate to a payment optimization system which provides an efficient means of determining an optimal payment method when purchasing a good and/or service using an online marketplace. The system examines the product being purchased, how much it costs, and what business is selling it to determine which linked payment option will yield the greatest benefit for the user. The system will also allow customers to set percent utilization limits across their various credit cards to better manage their credit score.

During use, the user (i.e., the customer) will use the wallet application or virtual card to facilitate in-store or online purchases. The system may then use the information sent from the merchant payment processor (cost of the product, what is the product, and where they are purchasing it) to select the ideal payment method for the customer, given their settings and preferences. The user will also be able to set percent utilization limits across their linked credit cards. All of these inputs, settings, preferences, and limits effect which linked payment option is selected for any given purchase to aid in the analysis and selection of a payment method for the good or service. The system provides an efficient and automated means of determining which payment method is most beneficial using various metrics including credit history, credit availability, credit utilization, benefits of the payment methods, etc.

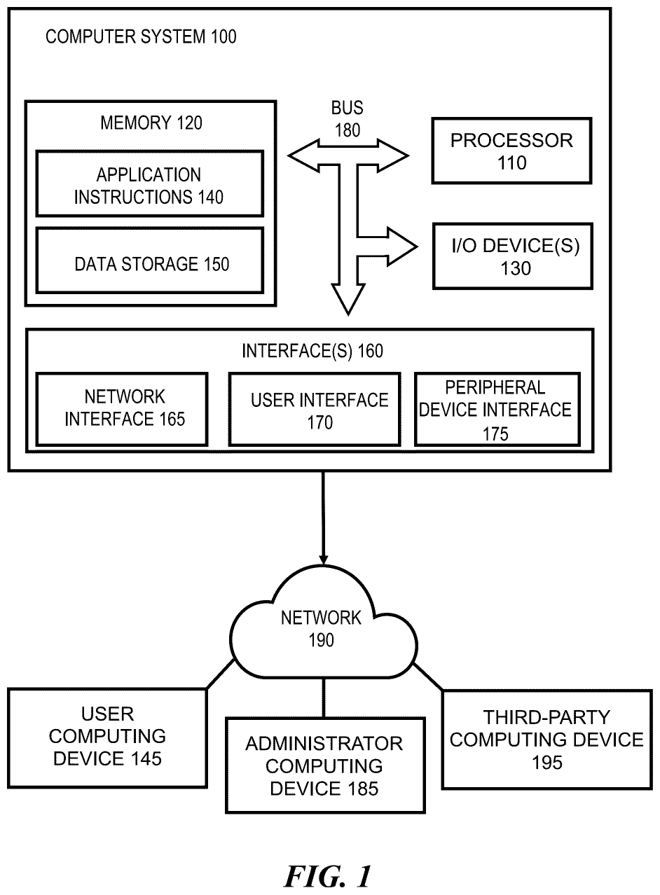

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

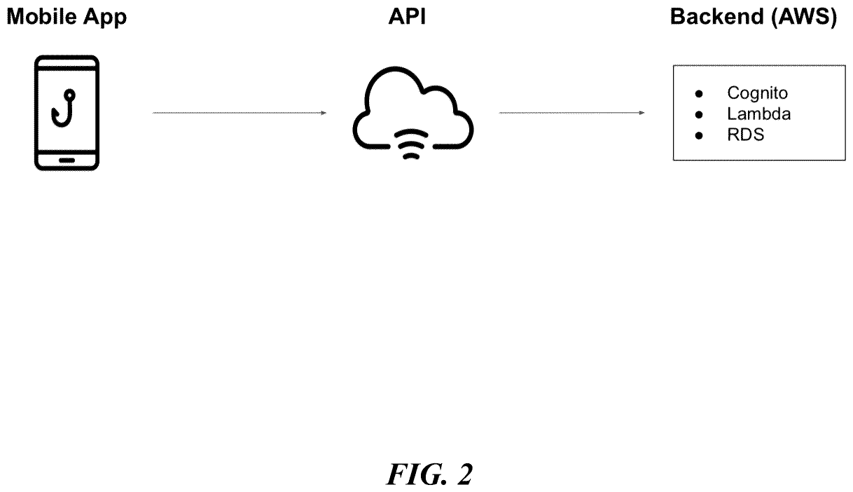

FIG. 2 illustrates a flowchart of the system infrastructure include the mobile application, API, and backend service. During use, the user will first shop and select one or more goods and/or services to be purchased using an online marketplace. Once the user has selected items or services they wish to purchase, the application server transmits this information to a finance and payment platform which provides access to the user's financial information. This allows the system to determine which methods of payment are available which then allows the system to analyze each method of payment to determine optimal choices for paying for the good and/or services they have selected. This can be done by assessing the user's available credit, available funds, benefits associated with each method of payment, etc.

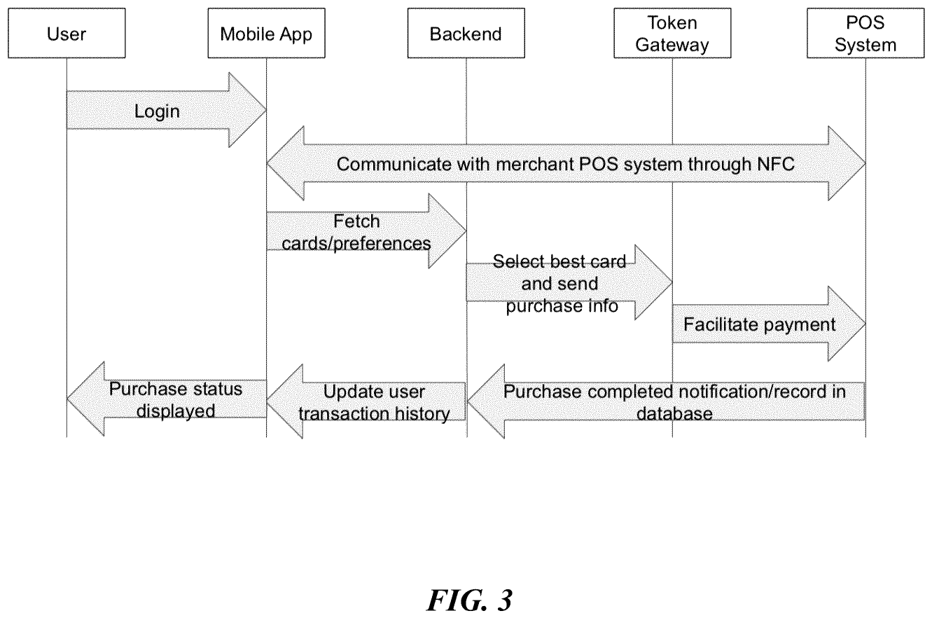

FIG. 3 illustrates the in-store purchase sequence for the payment optimization system, focusing on how the user's mobile application interacts with the backend infrastructure and a merchant's point-of-sale (POS) system to complete a transaction. The process begins with the user logging into the mobile application, which securely authenticates the session and retrieves relevant card data and optimization preferences. This includes stored payment methods, user-defined utilization settings, and reward priorities that will be used to guide the optimization decision. The mobile app then prepares to interact with the POS system through a near-field communication (NFC) channel.

After the application has fetched the user's preferences and available cards, it evaluates the purchase parameters—such as transaction amount, merchant category, and user constraints—using its built-in decision logic. Based on this analysis, the system selects the optimal payment method in real time and formats the transaction request. This selected card data is securely sent to the merchant's POS system to facilitate payment through the NFC interface. The interaction with the POS system is performed seamlessly, without requiring the user to manually select a card at the time of purchase.

Once the transaction is processed by the merchant and approved by the card issuer, the backend system updates the user's transaction history within the remote database. The purchase completion is logged, and a status notification is sent back to the mobile application for real-time display. The mobile app reflects the successful transaction by showing a confirmation message and updated financial data, such as available credit, new reward earnings, and updated utilization metrics. This ensures the user has immediate feedback and visibility into the optimization process and its results.

The entire sequence shown in FIG. 3 highlights the real-time and intelligent nature of the in-store payment optimization system. It leverages cloud-based services and mobile NFC capabilities to make smart, user-aligned payment decisions with minimal user intervention. This integration provides a frictionless experience that improves financial outcomes while simplifying the purchasing process.

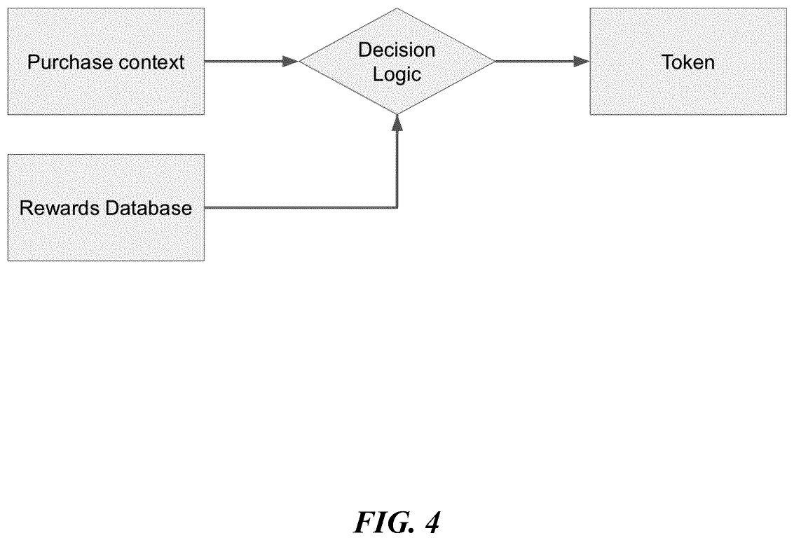

FIG. 4 illustrates a functional architecture of the decision logic used by the payment optimization system, with particular emphasis on how reward data and user-specific configurations are integrated into the optimization engine. At the center of this diagram is the Decision Logic component, which acts as the core analytical engine responsible for evaluating transaction context and selecting the most appropriate payment method. This component receives inputs from both static user preferences and dynamic transaction data. By processing these inputs together, the system makes a data-driven recommendation for which card or account to use for a specific purchase.

To the left of the decision logic module, a Purchase Context input channel feeds in real-time transaction details such as cost, merchant identifier, category code, and location. This information is critical for evaluating eligibility criteria, such as promotional cashback bonuses or airline mileage multipliers tied to merchant categories. The context data is often retrieved from either the point-of-sale (POS) system or the mobile application's frontend interface immediately before the transaction is finalized. These inputs help frame the optimization decision around the specifics of the current purchase, rather than using a static default rule.

Above the decision engine, a Rewards Database is shown as an additional data source. This database contains structured data regarding the user's accumulated reward balances, as well as the valuation and redemption options tied to each loyalty program. For example, it includes values like “$0.03 per point for flights” or “$0.01 per dollar cashback.” The system retrieves this data to calculate the reward yield for each eligible card and incorporate it into the scoring algorithm. This integration allows the optimization engine to assess not just availability or utilization thresholds, but also tangible user benefit in the form of future redeemable value.

Completing the architecture is the Token component, depicted as an authentication and security interface ensuring secure transmission of sensitive data between modules. Tokens are used to authorize access to user-specific card data and transaction records without transmitting actual credentials. This ensures that all backend interactions with financial accounts and rewards services remain secure and privacy-compliant. Overall, FIG. 4 encapsulates the intelligent and secure foundation upon which the system's real-time payment decisioning is built, offering both personalization and efficiency for the end user.

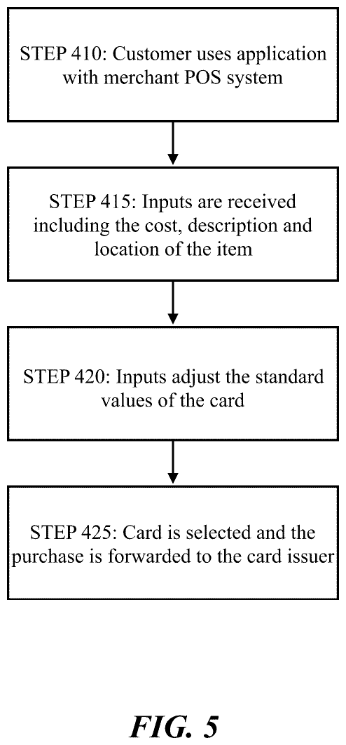

FIG. 5 illustrates a flowchart 400 showing a process for selecting an optimal method of payment for a good and/or service. In step 410, the user utilizes the application program which is in communication with an online marketplace and merchant point-of-sales (POS) system to select one or more good(s) and/or service(s) the user would like to purchase. In step 415, the system receives the good and/or service information including the cost, item description, and provider. In step 420, the system adjusts the values for each method of payment to attribute a value to the adjustment. This allows the system to determine the optimal payment method by comparing the adjustment made for each method of payment. In step 425, a payment method is selected, and the purchase is executed.

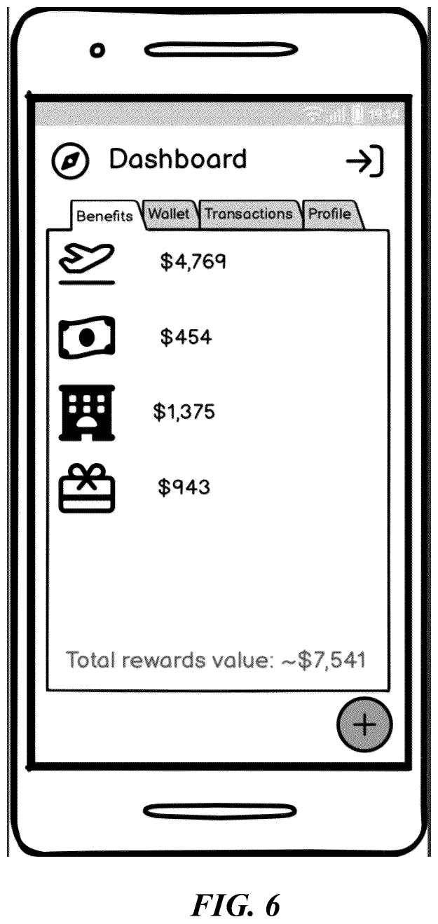

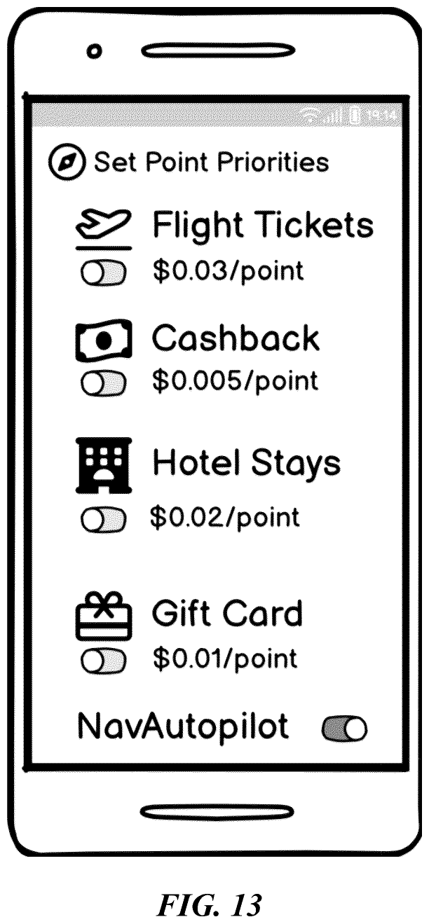

FIGS. 6-13 illustrate various exemplary screenshots of the user interface of the system for optimizing payments for online purchases.

FIG. 6 illustrates an exemplary graphical user interface (GUI) dashboard of the payment optimization application, as presented to the user on a computing device such as a smartphone or tablet. This dashboard serves as the primary user interface through which the user can view a summary of their financial data, linked payment methods, and optimization metrics. The design provides a clear and concise display of financial performance indicators, which are aggregated and visually segmented for ease of interpretation. This includes reward balances across various categories, such as travel miles, cashback, hotel points, and gift cards.

The dashboard includes multiple panels or sections that report the total value of available rewards. These totals are broken down into categories, and each category is associated with a visual indicator, such as a horizontal bar or colored highlight, that helps the user quickly identify which reward type holds the highest value. For example, the dashboard may display that the user has accumulated approximately $7,541 in total rewards, with breakdowns such as $4,769 in travel miles, $454 in cashback, $1,375 in hotel points, and $943 in gift card value. This categorization assists users in understanding how their spending behavior contributes to various types of rewards.

In addition to reward tracking, the dashboard interface allows users to access further details about their spending preferences and utilization settings. It provides entry points for configuring point priorities, setting custom utilization thresholds, and activating features such as autopilot optimization. These interface elements are interactive and enable real-time updates to the optimization logic based on user preferences. For example, users can modify the relative point values assigned to flight miles versus cashback, and the system will immediately adjust future optimization decisions based on these updates.

The visual structure of the dashboard is designed to be both informative and user-friendly, with a strong emphasis on usability and quick access to key information. By centralizing all relevant financial metrics into a single interface, the dashboard empowers users to make informed decisions about their spending and rewards strategies. Furthermore, this unified interface enhances transparency by showing how optimization outcomes are calculated, building user trust in the system's automated decision-making. Overall, the FIG. 4 dashboard serves as a control center for both monitoring and configuring the core functionalities of the payment optimization system.

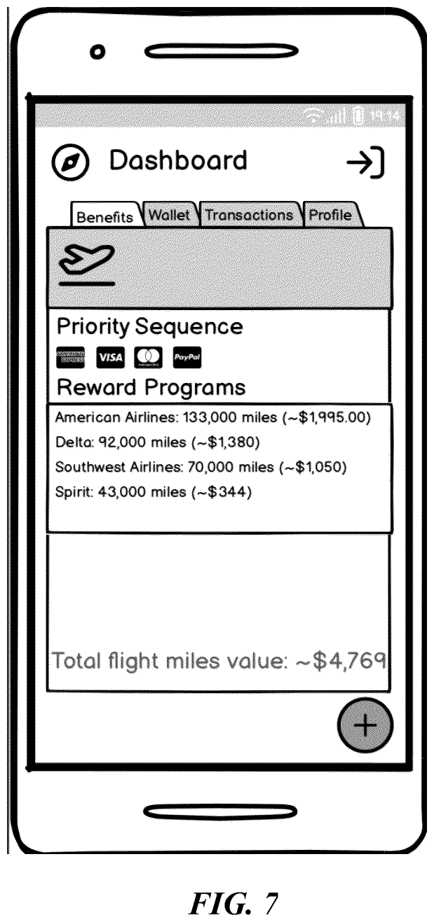

FIG. 7 illustrates the dashboard interface specifically configured to display flight-related reward balances. This interface presents the total value of flight miles accumulated by the user across various airline loyalty programs. Each program is listed with both the number of miles earned and the estimated monetary value associated with those miles. For example, users may see that they have accumulated 133,000 miles with American Airlines (valued at approximately $1,995), 92,000 with Delta (about $1,380), and additional balances with Southwest and Spirit.

This visualization helps users assess the effectiveness of their travel-related spending and determine which programs yield the highest return. The interface may also rank these rewards in priority order based on their conversion value per mile or strategic importance to the user. These insights are particularly useful for frequent travelers seeking to consolidate loyalty rewards for a specific redemption goal, such as an international flight or a status upgrade.

The dashboard also allows users to adjust the reward priorities within flight programs. By adjusting settings, users can inform the optimization engine to favor certain programs over others when recommending a payment method. This level of customization supports long-term travel goals and enhances reward redemption efficiency. The clear organization of data and reward values in FIG. 7 simplifies tracking and aligns the payment strategy with personalized travel objectives.

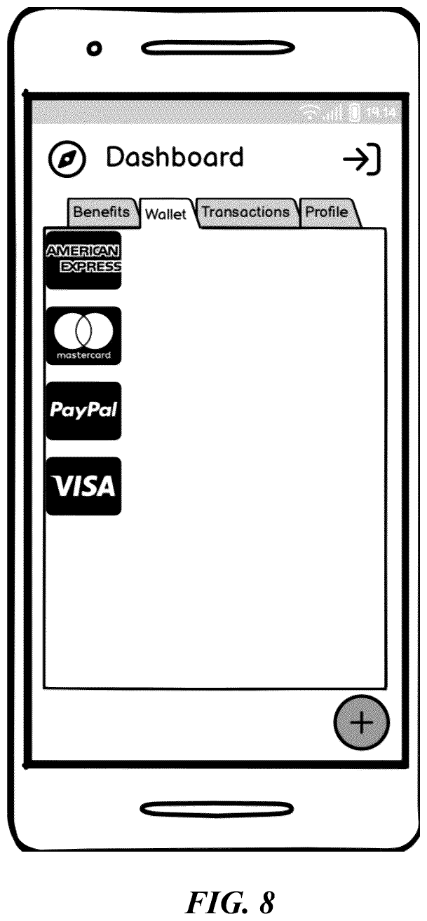

FIG. 8 displays a screenshot of the cashback reward interface within the optimization system. This panel aggregates the total cashback value earned across all linked payment methods and displays individual contributions from each provider. Examples may include $160 from a VISA card, $143 from a MasterCard, $82 from an AMEX account, and $69 from PayPal. Each entry is presented alongside a bar or visual cue that indicates its relative weight within the total cashback portfolio.

This breakdown allows users to see which accounts are generating the most cashback and adjust their usage accordingly. For instance, if a user observes that one card is consistently underperforming despite high usage, they may choose to deprioritize it within the optimization settings. The system's scoring engine can then route future transactions through higher-performing cards to maximize returns.

In addition to historical performance, the dashboard may show trending data or monthly changes in cashback accumulation. This time-based view supports ongoing financial analysis and helps users measure the effectiveness of their optimization preferences over time. Ultimately, FIG. 6 offers a clear and data-rich interface for managing and improving cashback rewards.

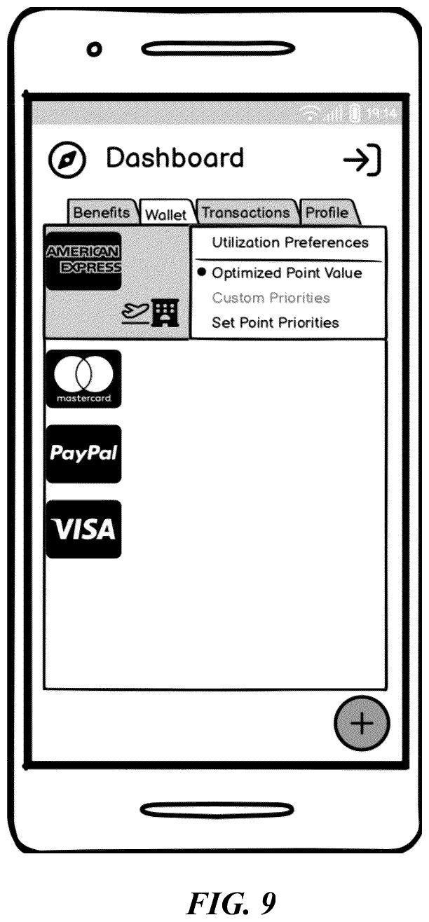

FIG. 9 illustrates the hotel points reward interface, which consolidates reward point balances across several hospitality loyalty programs. Users can view accumulated point totals for programs such as Marriott Bonvoy, Hilton Honors, and Wyndham Rewards. Each entry includes the number of points and their estimated monetary value, such as 125,000 Marriott Bonvoy points valued at $875.00.

The dashboard enables users to monitor their progress toward specific redemption goals, such as free hotel stays or upgrades. Users can prioritize hotel points within the system settings to direct more purchases toward cards affiliated with preferred hotel chains. This configuration is particularly valuable for frequent travelers who seek to centralize their lodging rewards or maintain elite status.

By including estimated redemption value, the interface demystifies the often opaque valuation of hotel loyalty programs. The interface may also provide historical views or alerts when users are nearing a reward threshold. FIG. 9 enhances strategic decision-making for hotel-related purchases and serves as a visual planning tool for hospitality benefits.

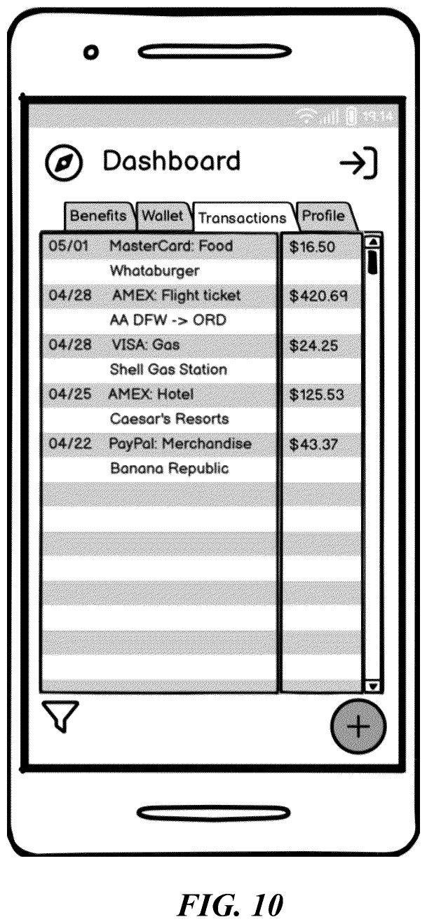

FIG. 10 presents the gift card rewards dashboard, which displays the total value of accumulated gift card credits earned through specific payment methods or reward redemptions. Each row in the interface shows the issuing provider (e.g., PayPal, VISA, AMEX, MasterCard) along with the corresponding reward value, such as $420 from PayPal or $321 from VISA.

This dashboard helps users understand the tangible value of their alternative rewards and decide how to use or convert those assets. In some configurations, the interface may allow users to redeem points directly for gift cards within the app. Users can also set priorities to determine whether gift card value should be emphasized in the scoring model relative to other reward types like cashback or miles.

The visual design mirrors that of previous reward dashboards, maintaining interface consistency. It enables users to recognize trends and allocate spending to sources that yield the highest gift card returns. FIG. 10 adds dimension to the user's reward strategy by including non-travel and non-cash benefits in the optimization calculation.

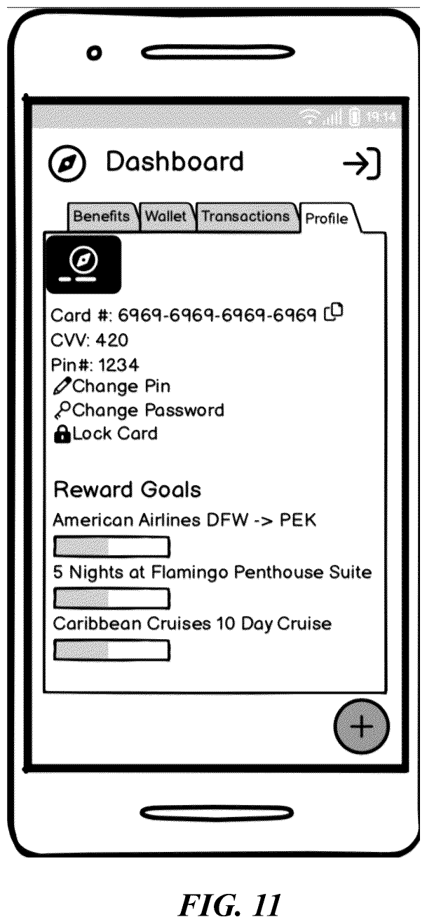

FIG. 11 depicts the utilization preferences configuration panel, which allows users to define how much of their available credit they wish to use for each linked payment method. Users may input specific utilization limits, such as capping one card at 60 percent of its available credit. The interface shows both per-card and overall utilization metrics.

This feature is vital for users who are managing their credit scores or avoiding penalties from high utilization. The system uses these settings during transaction analysis to automatically exclude cards that would violate the defined thresholds if selected. The preferences are dynamic and can be adjusted at any time, allowing users to react to changes in their financial situation.

The interface may also include alerts or suggestions when a card is nearing its cap. This proactive guidance helps users maintain control over their credit profiles. FIG. 11 plays a central role in aligning optimization logic with the user's credit management strategy.

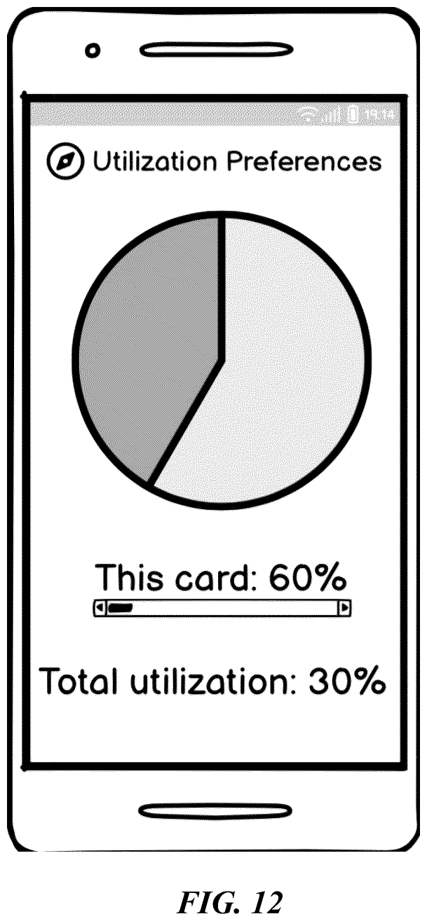

FIG. 12 illustrates the point priority settings panel, where users assign monetary values to different reward types. Categories include flight tickets, cashback, hotel stays, and gift cards, each with a designated value per point. For example, users may specify $0.03 per point for flights, $0.01 for cashback, $0.02 for hotels, and $0.005 for gift cards.

These values are used by the scoring algorithm to compare the projected return from each reward type during transaction evaluation. This ensures that optimization is tailored not just to account metrics but also to how the user values different outcomes. Users can change these values at any time, providing dynamic control over the reward strategy.

The panel also includes a feature called NavAutopilot, which activates full automation of the optimization system using the provided settings. When enabled, the system independently selects and executes the most advantageous payment method for each transaction. FIG. 10 enhances system intelligence while giving users meaningful control over strategic inputs.

FIG. 12 provides a composite overview of the dashboard environment, illustrating the integration of various modules described in previous figures. This figure may include visual elements from the benefits panels, wallet views, transaction logs, and profile settings. It serves as a holistic reference for how the system components interoperate in a cohesive user interface.

The composite view reinforces the system's goal of providing centralized financial oversight and optimization. By combining reward tracking, utilization management, and decision automation into a single interface, the user is empowered to manage complex financial relationships with ease. FIG. 12 also highlights the seamless user experience achieved through thoughtful design.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for optimizing and automating the selection of a payment method used for online purchases, comprising:
at least one user computing device in operable connection with a user network;
an application server in operable communication with the user network, the application server configured to host an application program for analyzing and determining an optimal method of payment, the application program having a user interface module for providing access to the application program via the at least one user computing device;
an online marketplace to permit the user to select one or more goods and services;
an analysis module for determining an optimal payment method using one or more financial metrics.

2. The system of claim 1, wherein the analysis module applies a weighted scoring algorithm that assigns value to reward points, cashback potential, and credit utilization.

3. The system of claim 1, wherein the application program further comprises a dashboard interface for displaying the user's total available credit, reward balances, and transaction history.

4. The system of claim 1, further comprising an account linking module that securely connects to third-party financial services using tokenized API protocols.

5. The system of claim 1, wherein the financial metrics include user-defined maximum utilization thresholds per payment method.

6. The system of claim 1, wherein the online marketplace comprises a third-party website, e-commerce platform, or in-store mobile point-of-sale system.

7. The system of claim 1, wherein the optimal payment method is selected based on at least one of: reward point valuation, loyalty tier progression, or promotional interest rates.

8. A method for automatically selecting a payment method for a transaction, the method comprising the steps of:
at least one user computing device in operable connection with a user network;
receiving transaction data from a user device, the transaction data including cost, vendor, and item description;
accessing a plurality of stored payment account profiles linked to the user;
analyzing the transaction data against user-defined preferences and one or more financial metrics comprising credit availability, utilization limits, and reward structures;
determining a ranked list of payment methods based on the analysis; and
automatically selecting and initiating the transaction using the highest-ranked available payment method.

9. The method of claim 8, further comprising the step of applying a service fee to the selected payment method and routing the fee to a linked user account.

10. The method of claim 8, wherein analyzing the transaction data includes calculating the projected credit utilization after the transaction for each candidate payment method.

11. The method of claim 8, further comprising displaying to the user a list of ranked payment options prior to transaction execution.

12. The method of claim 8, further comprising filtering out payment methods that would exceed preset utilization limits if used for the transaction.

13. The method of claim 8, wherein the transaction data is received from an in-store mobile wallet or NFC-enabled point-of-sale interface.

14. The method of claim 8, wherein reward yield is determined based on current vendor eligibility, purchase category, and reward program rules.

15. The method of claim 8, further comprising a learning module that refines future payment selections based on historical user behavior and reward optimization outcomes.

16. A non-transitory computer-readable medium storing instructions that, when executed by one or more processors, cause the system to perform operations comprising:
providing a user interface for inputting account credentials and setting payment preferences;
retrieving, via an API, real-time account data for a plurality of linked payment methods;
calculating a utilization percentage and reward yield for each payment method;
scoring each payment method based on the calculated metrics and user-defined weights; and
selecting a payment method that maximizes user-defined benefit criteria while maintaining compliance with specified utilization thresholds.

17. The computer-readable medium of claim 16, wherein the instructions further cause the system to track cumulative monthly utilization across all linked accounts and issue warnings when thresholds are approached.

18. The computer-readable medium of claim 16, wherein the reward yield includes estimated point value per transaction type selected by the user.

19. The computer-readable medium of claim 16, wherein the user interface enables customization of optimization rules by assigning point values or monetary equivalents to various reward types.

20. The computer-readable medium of claim 16, further comprising instructions to detect duplicate or recurring transactions and apply historical optimization data to accelerate future payment selections.
